(19) United States
(12) Patent Application Publication
(10) Pub. No.: US 2020/0347855 A1
(43) Pub. Date: Nov. 5, 2020

(54) VALVE

(71) Applicant: HYDAC FLUIDTECHNIK GMBH, Sulzbach/Saar (DE)

(72) Inventors: Peter BRUCK, Althornbach (DE); Frank SCHULZ, Blieskastel-Bierbach (DE)

(21) Appl. No.: 16/643,892

(22) PCT Filed: Sep. 5, 2018
(86) PCT No.: PCT/EP2018/073823

§ 371 Date: Jun. 16, 2020

(30) Foreign Application Priority Data
Sep. 6, 2017 (DE) 10 2017 008 359.2

(51) Int. Cl. F15B 13/04; B66F 9/22; F15B 11/05

(52) U.S. Cl. CPC F15B 13/0417; B66F 9/22; F15B 2013/004; F15B 2211/57; F15B 2211/6658; F15B 11/05

(57) ABSTRACT

A valve, in particular for use as a pressure maintenance-type component (38) in hydraulically actuated hoisting devices (2), having a valve housing (54), which has a control port (40) plus a fluid inlet (64) and a fluid outlet (66), and having a regulating piston (68) longitudinally displaceably arranged in the valve housing (54), which regulating piston, against the action of an energy storage device (70), in particular in the form of a compression spring, brings the regulating piston (68) into at least one position forming a fluid-conveying connection between the fluid inlet (40) and the fluid outlet (66) or blocks this connection by means of a control pressure existing at the control port (40), is characterized in that a first diaphragm (88) is arranged in the regulating piston (68), which connects the control port (40) to a receiving space (62) for the energy storage device (70) in a fluid-conveying manner, and in that a second diaphragm (90) is arranged in an intermediate part (72) in the valve housing (54), by means of which the receiving space (62) can be connected to a compensating chamber (92), which connected to the fluid outlet (66) in a fluid-conveying manner (98).

The invention relates to a valve, in particular for use as a pressure maintenance-type component in hydraulically actuated hoisting devices, having a valve housing, which has a control port plus a fluid inlet and a fluid outlet, and having a regulating piston longitudinally displaceably arranged in the valve housing, which regulating piston, against the action of an energy storage device, in particular in the form of a compression spring, brings the regulating piston into at least one position forming a fluid-conveying connection between the fluid inlet and the fluid outlet or blocks this connection by means of a control pressure existing at the control port.

The use of pressure maintenance-type components in hydraulically operated hoisting devices is state of the art. Document DE 102 02 607 C1 discloses by way of example the arrangement of a pressure maintenance-type component for influencing the lowering behavior in a hoisting device for raising and lowering loads, wherein the pressure maintenance-type component is arranged in a return line of a relevant lifting cylinder. Another preferred application is the use in hoisting devices, which are equipped with a hoist damper, which can be activated or deactivated. In this case, a pressure maintenance-type component is used to ensure that the accumulator pressure at an assigned damping accumulator automatically follows the load pressure of the relevant hoist cylinder both for activated and deactivated hoist damper. This prevents any uncontrolled lifting or lowering of the hoist in the event the hoist damper is activated after a previous deactivated operation.

Based on this state of the art, the invention addresses the problem of providing a valve, which, as a pressure maintenance-type component for use in hydraulically operated hoisting devices equipped with hoist damping, is characterized by a particularly favorable operating behavior.

According to the invention, this object is achieved by a valve having the features of claim 1 in its entirety.

According to the characterizing part of claim 1, an essential special feature of the invention is that a first diaphragm is arranged in the regulating piston, which connects the control port to a receiving space for the energy storage device in a fluid-conveying manner, and that a second diaphragm is arranged in an intermediate part inside the valve housing, by means of which diaphragms the receiving space can be connected to a compensating chamber, which is connected to the fluid outlet in a fluid-conveying manner. Owing to the arrangement of two diaphragms which, on the one hand, are routed from the control port to the receiving space holding the spring applying load on the regulating piston and, on the other hand, are routed from the compensating chamber bearing the pressure of the fluid outlet to the receiving space, the valve represents a kind of servo-controlled pressure maintenance-type component. The combination of the two diaphragms and the spring arranged therebetween amplifies the regulating pressure of the compensating piston generated by the spring. This is favorable for a compact design having a small-sized pressure spring in the manner of a so-called cartridge valve, which is particularly suitable for use in hoisting devices of mobile units, such as forklifts, mobile cranes or the like, where the installation space for the hydraulic components is limited.

Because, due to the function of the pressure maintenance-type component, the pressure at the damping accumulator follows the load pressure at the lifting cylinder, the damping accumulator is automatically depressurized when the lifting cylinder is lowered and is repressurized when the lifting cylinder is raised again. The continuous pressurization process, which also occurs when the damping mode is deactivated, i.e. when the damping accumulator is inoperable, requires pump output, consuming energy and reducing the lifting speed. In the state of the art, an additional switching valve, which blocks this connection in deactivated damping mode and prevents the loading process of the accumulator in this mode, is inserted between the pump side and the pressure maintenance-type component, preventing this effect.

With regard to this problem, in a particularly advantageous exemplary embodiment of the design of the valve according to the invention, the second diaphragm can be closed by means of a servo-control device, which can be controlled by a solenoid. If a solenoid is used, the closing force of which is greater than the hydraulic force acting on the regulating piston, the servo oil is prevented from flowing when the solenoid is actuated and as a consequence the regulating piston of the pressure maintenance-type component remains in the closed position, effectively blocking the pressure maintenance-type component. In this way, the locking function usually provided by the additional switching valve can be integrated into the cartridge of the pressure maintenance-type component, resulting in corresponding savings in design effort and installation space of the damping device.

In advantageous exemplary embodiments, the servo control device has a servo cone, which interacts with a valve seat on the intermediate part and on which two energy storage devices, in particular in the form of compression springs, act in and against the direction of action of the solenoid.

The arrangement can be advantageous in such a way that the compensating chamber is accommodated, at least partially, in the intermediate part, which establishes a fluid-conveying connection to a collecting chamber as a further part of the compensating chamber, which is permanently connected in a fluid-conveying manner to the fluid outlet in the valve housing via at least one fluid-conveying passage-way.

In advantageous exemplary embodiments, the actuating part of the solenoid is guided in a connecting part of the solenoid provided for connecting the solenoid to the valve housing, which connecting part, at least partially, accommodates one energy storage device of the servo control device and is connected to the intermediate part, wherein the latter and the connecting part are arranged stationarily on the valve housing.

In advantageous exemplary embodiments, the regulating piston, at least in the area of the control port and at least in the area, in which, at least partially, one of the energy storage devices is accommodated, is designed as a hollow piston, wherein one diaphragm, designed as a screw-in piece, is inserted into the regulating piston, both cavities of which are permanently connected to each other in a fluid-conveying manner. If the diaphragm is designed as a screw-in piece, identical regulating pistons can be fitted with different diaphragms to adapt them to the desired function.

The regulating piston can advantageous be equipped with a stop part on the side of the intermediate part, which can be brought into contact with the valve housing and intermediate part, respectively, in one and the other stop position, respectively.

For the design of the valve in the so-called cartridge design, the arrangement can be such that the control port is inserted into the valve housing in the axial direction and the fluid inlet and the fluid outlet extend through the valve housing in the radial direction, wherein the hollow piston in conjunction with the valve housing defines an annular space on the outer circumference, which annular space completely transverses the fluid outlet in the other stop position of the regulating piston.

The subject matter of the invention is also a device for attenuating the hoist for at least one hydraulic load, in particular in the form of a hydraulic power cylinder, wherein the device has the features of patent claim 10.

Below the invention is explained in detail with reference to exemplary embodiments shown in the drawing.

In the Figures:

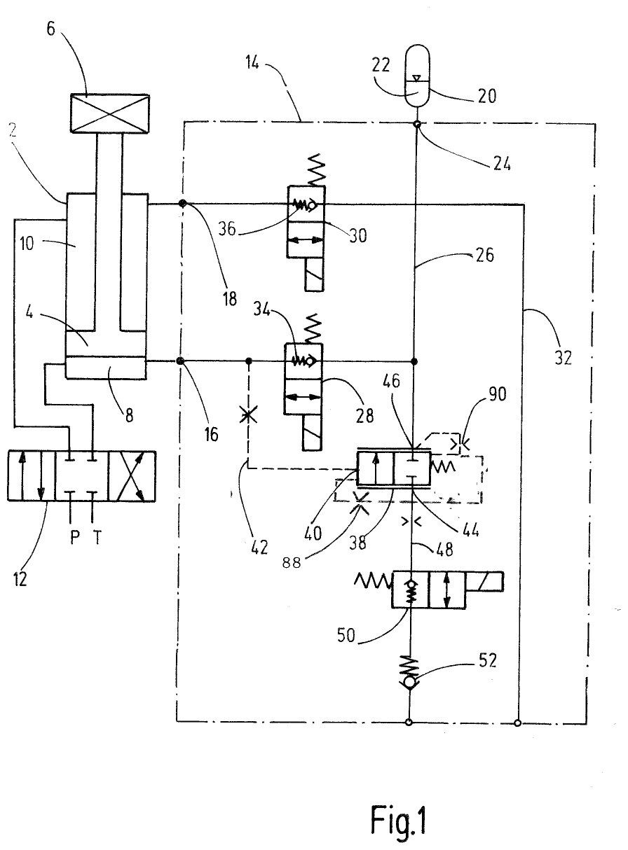

FIG. 1 shows a symbolic representation of the circuit of a hydraulically actuated hoisting device provided with hoist damping;

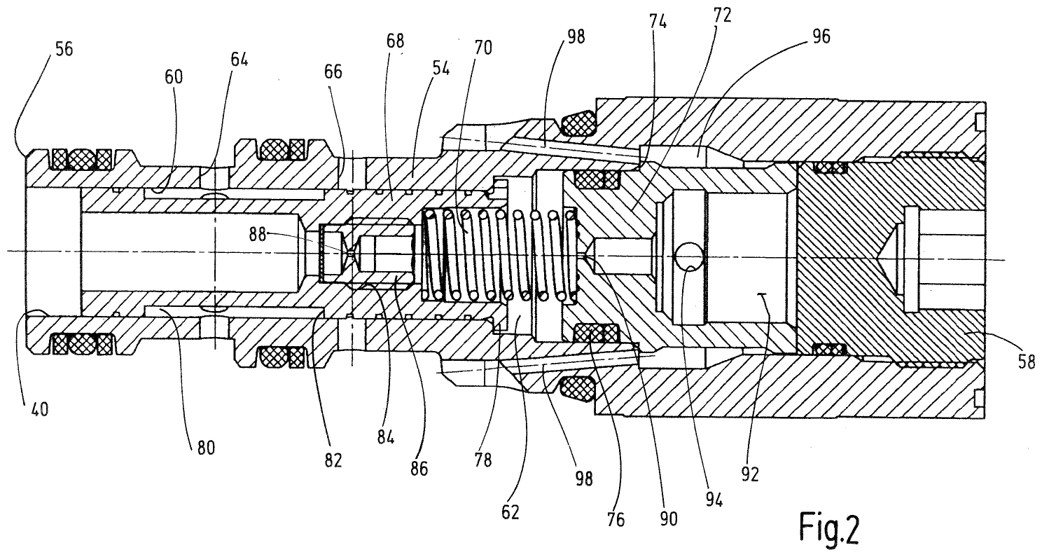

FIG. 2 shows a longitudinal section of a design example, drawn approximately 3½ times enlarged compared to an exemplary embodiment of the valve in accordance with the invention, which is used as a pressure maintenance-type component in the hoisting device of FIG. 1;

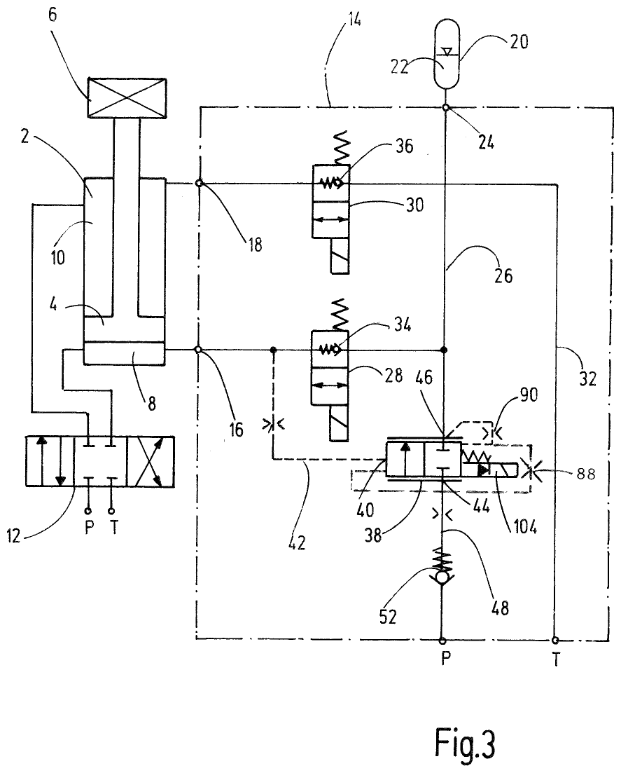

FIG. 3 shows a symbolic representation of the circuit of a hydraulically actuated hoisting device provided with hoist damping, which has a valve as a pressure maintenance-type component according to a second exemplary embodiment of the invention; and

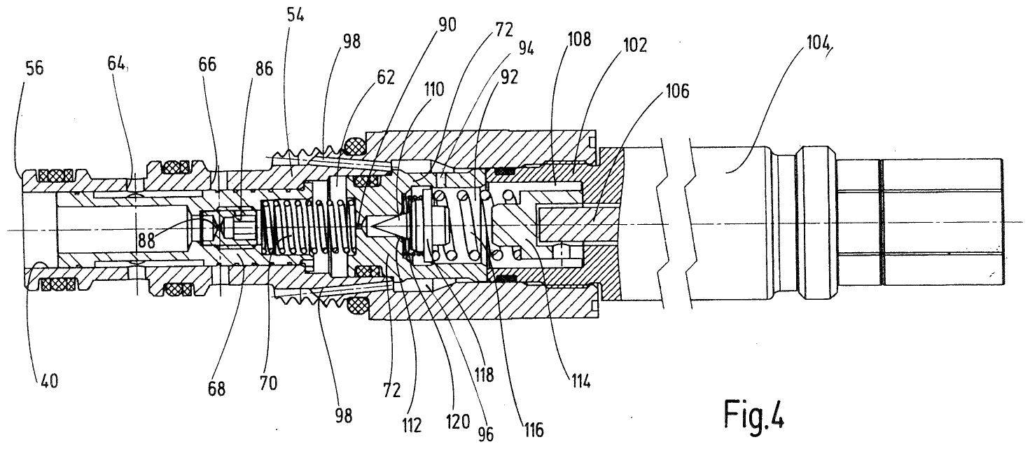

FIG. 4 shows a longitudinal section of the second design example of the valve according to the invention.

In FIG. 1a hydraulically actuated lifting cylinder, the working piston 4 of which can be used to raise and lower a load 6, is designated by 2. To control the lifting cylinder 2, its working chambers 8 and 10, separated from the working piston 4, are connected to a 4/3-way spool valve 12, which can be controlled by a relevant operator and which has a pressure supply port P and a tank port T routed to the tank side. The hoisting device is equipped with a hoist damper 14, which is connected to the piston-side working chamber 8 via a connection point 16 and to the rod-side working chamber 10 of the lifting cylinder 2 via a connection point 18. In accordance with the state of the art, the hoist damper 14 has a hydropneumatic damping accumulator 20, the oil side 22 of which is connected to an accumulator line 26 at a connection point 24.

To bring the hoisting device into an operating state in which the hoist damper 14 is deactivated or into an operating state in which the hoist damper 14 is activated, two electrically actuated switching valves 28 and 3o are provided, which can be switched against a mechanical restoring force into a pass-through position to activate the hoist damper 14. In the pass-through position, the switching valve 28 connects the piston-side working chamber 8 of the lifting cylinder 2 to the accumulator line 26 via the connection point 16. In the open position, the other switching valve 3o connects the rod-side working chamber10 of the lifting cylinder 2 to a return line 32 routed to tank side T. In FIG. 1, which shows the state of the deactivated hoist damper 14, in the absence of electrical actuation, the switching valves 28 and 3o are in a switching position, in which the switching valve 28 uses a non-return valve 34 to block the fluid from flowing from the working chamber 8 to the accumulator line 26, but permits the fluid to flow in the opposite direction. In this switching position, the other switching valve 3o uses a non-return valve 36 to block the fluid flow from the rod-side working chamber10 of the stroke cylinder 2 to the return line 32, but permits the fluid to flow in the opposite direction.

In the manner typically used for hoist damping, a pressure maintenance-type component ₃8 is inserted between the accumulator line 26 and the pressure supply port P, the control port 4o of which is connected to the port 16 via a control line 42, which is connected to the piston-side working chamber 8 of the lifting cylinder 2. The load pressure of the working chamber 8 of the lifting cylinder 2 therefore pressurizes the control port 40 via the control line 42. Because the inlet 44 of the pressure maintenance-type component 38 is connected to the pressure supply port P via a load line 48 and the outlet 46 is connected to the accumulator line 26, the accumulator pressure of the damping accumulator 20 follows the load pressure of the working chamber 8 of the lifting cylinder 2.

When operating the hoisting device at deactivated hoist damper 14, the piston-side working chamber 8 of the lifting cylinder 2 is connected to the tank side T via the 4/3-way valve 12 during lowering operations. For the switching position of the switching valve 28 shown in FIG. 1, therefore an unloading process of the damping accumulator 20 takes place via the former's non-return valve 34 during every lowering operation. As due to the function of the pressure maintenance-type component 38, the pressure of the damping accumulator 20 follows the load pressure in the working chamber 8 of the pressure cylinder 2, a new loading process of the damping accumulator 20 takes place via the loading line 48 with every new lifting process. To avoid successive loading processes of the damping accumulator 20 during successive lowering and lifting processes of the lifting cylinder 2 for a deactivated hoist damper 14, in the state of the art a switching valve 50 is inserted in the loading line 48 between pressure maintenance-type component 38 and pressure supply connection P, which prevents a loading flow in the direction of the damping accumulator 20 when the hoist damper 14 is deactivated and only opens the loading line 48 when the hoist damper 14 is activated. In addition, the loading line 48 is protected against reverse flow in the direction of the pressure supply port P by a check valve 52. The diaphragm or throttle in the control line 42 shown in FIG. 1 and the 30 diaphragm or throttle in the loading line 48 (each without reference mark) are used to improve control and fine tuning of the hydraulic circuit (also FIG. 3).

FIG. 2 shows in a separate illustration the design of the pressure maintenance-type component 38 according to a first exemplary embodiment of the invention. The valve, built in the so-called cartridge design, has a valve housing 54 having an open end 56 and a closed end sealed in a pressure-tight manner by a screwed-in end piece 58. The left housing section of the valve housing 54 can, in the manner typical for cartridges, as shown in FIG. 2, be installed in a valve block not shown. A guide cylinder 60 extends in the valve housing 54 from the open end 56 to a spring receiving chamber 62 having an enlarged inner diameter. In the area of the guide cylinder 60, the valve housing 54 has axially offset drilled holes 64 and 66, which form the access to the guide cylinder 60 and of which the drilled holes 64 nearest to the open end 56 form the fluid inlet 44 (FIG. 1) and the other drilled holes 66 form the fluid outlet 46 (FIG. 1). The open housing end 56 forms the control port 40 of the valve.

A regulating piston 68 is guided in the guide cylinder 60 for longitudinal movement, which regulating piston is designed as a hollow piston and is loaded at its inner end by a compression spring 70 provided as an energy storage device. The end of the compression spring 70 facing away from the regulating piston 68 is supported on an intermediate part 72, which is immobilized in the axial direction on the one hand by resting against a protrusion 74 of the valve housing 54 and on the other hand by resting against the end piece 58 and which seals the spring receiving chamber 62 by means of a sealing device 76.

In the unpressurized state shown in FIG. 2, the compression 70 spring moves the regulating piston 68 into an end position, in which an end stop part 78 of the regulating piston 68 rests against a housing protrusion located at the end of the spring receiving chamber 62. In the other end position, displaced against the force of the compression spring 70, the stop part 78 of the regulating piston 68 rests against the intermediate part 72. The regulating piston 68 has an outer annular space 8o into which the fluid inlet 44 formed by the drilled holes 64 opens and whose axially inner end forms a control edge 82. In the unpressurized state shown in FIG. 2, the control edge 82 is located in front of the drilled holes 66 at the end position of the regulating piston 68 shown, closing the fluid outlet 46. When the regulating positions of the regulating piston 68 are displaced against the force of the compression spring 70, the control edge 82 exposes the connection to the annular space 8o, wherein the control edge 82 completely passes over the drilled holes 66 of the fluid outlet 46 when the regulating piston 68 is moved to the right end position.

In the area adjacent to the spring receiving chamber 62, the regulating piston 68, which is designed as a hollow piston, has an area having a tapered inner diameter and a female thread 84, into which a screw-in piece 86 is screwed, in which a first diaphragm 88 is located, which connects the control input 4o to the spring receiving chamber 62. A second diaphragm 90 is formed in the intermediate part 72 adjacent to the spring receiving chamber 62, which connects the spring receiving chamber 62 to a compensating chamber 92 located in the intermediate part 72, which in turn is connected to a collecting chamber 96, which is located as an annular space between the outer circumference of the intermediate part 72 and the inside of the valve housing 54, via radial drilled holes 94. Inclined passage-ways 98 in the valve housing 54 are used to connect the collecting chamber 96 to the fluid outlet 46 formed by the drilled holes 66 via fluid guides in the valve block not shown, i.e. the pressure of the damping accumulator 20 is effective at the second diaphragm 90 via the passageways 98, the compensating chamber 96 and the compensating chamber 92. The combination of the two diaphragms 88 30 and 90 and the pressure spring 70 located in between forms a kind of servo control for the pressure maintenance-type component, wherein the servo oil flow flowing through the second diaphragm go amplifies the regulating pressure generated by the pressure spring 70.

FIG. 3 shows, like FIG. 1, the circuit of a hydraulically operated hoisting device, wherein the hoist damper 14 is based on a pressure maintenance-type component according to a second exemplary embodiment of the valve according to the invention, which is shown separately in longitudinal section in FIG. 4. The design of the valve housing 54 of the second exemplary embodiment corresponds to the first exemplary embodiment, as do the internal components, such as the regulating piston 54 including the first diaphragm 88, the compression spring 70, the intermediate part 72 as the end of the spring receiving chamber 62 and the second diaphragm go. In contrast to the first exemplary embodiment, the compensating chamber 92 formed in the intermediate part 72 is not closed by a closed end piece 58, but is replaced by a connecting part 102 screwed into the valve housing 54 for an actuating solenoid 104. Like the end piece 58 of the first exemplary embodiment, the connecting part 102 rests against the intermediate part 72 to immobilize the latter.

The solenoid 104 has an axially movable actuating part 106, which travels to the left in FIG. 4 when the magnet104 is energized. The actuating part 106, which is displaceably guided in the connecting part 102, extends into a chamber 108 formed in the connecting part 102, which forms a continuation of the adjoining compensating chamber 92 in the intermediate part 72. The actuating part 106 is used to control a servo cone 110, for which a valve seat 112 is formed on the intermediate part 72. It is located on the intermediate part 72 in front of the access to the second diaphragm go, i.e. it can be closed by the servo cone 110. The free end of the actuating part 106 rests on a pressure piece 114 located in chamber 108, on which one end of a second compression spring 116 rests, the other end of which rests against a pressure disk 118, which forms a rear part of the valve cone 110 having an enlarged diameter. A third compression spring 120 is inserted between the pressure plate 118 and the intermediate part 72, the spring force of which is lower than that of the other compression spring 116 resting on the pressure plate 118, for resetting the servo cone 110, i.e. lifting it off the valve seat 112 when the solenoid 104 is not energized.

In this arrangement, the second diaphragm go can be closed by means of the servo cone 110 when the solenoid 104 is actuated or opened by means of the restoring force of the third compression spring 120 when the solenoid 104 is not actuated. When the second diaphragm go is closed by the solenoid 104, the servo oil is prevented from flowing, i.e. the regulating piston 68 closes the connection between the fluid inlet 44 and the fluid outlet 46. When used as a pressure maintenance-type component 38 with the hoist damper 14, as shown in FIG. 3, the valve not only takes over the function of the pressure maintenance-type component 38 when the hoist damper 14 is activated, but also, when the hoist damper 14 is deactivated, the valve additionally takes over the function of the switching valve 50 of FIG. 1, which blocks the loading line 48, and replaces the former.

1. A valve, in particular for use as a pressure maintenance-type component (38) in hydraulically actuated hoisting devices (2), having a valve housing (54), which has a control port (40) plus a fluid inlet (64) and a fluid outlet (66), and having a regulating piston (68) longitudinally displaceably arranged in the valve housing (54), which regulating piston, against the action of an energy storage device (70), in particular in the form of a compression spring, brings the regulating piston (68) into at least one position forming a fluid-conveying connection between the fluid inlet (40) and the fluid outlet (66) or blocks this connection by means of a control pressure existing at the control port (40), characterized in that a first diaphragm (88) is arranged in the regulating piston (68), which connects the control port (40) to a receiving space (62) for the energy storage device (70) in a fluid-conveying manner, and in that a second diaphragm (90) is arranged in an intermediate part (72) in the valve housing (54), by means of which the receiving space (62) can be connected to a compensating chamber (92), which connected to the fluid outlet (66) in a fluid-conveying manner (98).

2. The valve according to claim 1, characterized in that the second diaphragm (90) can be closed by means of a servo control device (110), which can be actuated by a solenoid (104).

3. The valve according to claim 1 or 2, characterized in that the servo control device has a servo cone (110), which interacts with a valve seat (112) on the intermediate part (72) and on which two energy storage devices (116, 120), in particular in the form of compression springs, act in and against the direction of action of the solenoid (104).

4. The valve according to claim 1 or 2, characterized in that the compensating chamber (92) is accommodated, at least partially, in the intermediate part (72), which establishes a fluid-conveying connection 94)to a collecting chamber (56) as a further part of the compensating chamber (92), which is permanently connected in a fluid-conveying manner to the fluid outlet (66) in the valve housing (54) via at least one fluid-conveying passage-way (98).

5. The valve according to any one of the preceding claims, characterized in that the actuating part (106) of the solenoid (104) is guided in a connecting part (102) of the solenoid (104) provided for connecting the solenoid (104) to the valve housing (54), which connecting part, at least partially, accommodates one energy storage device (116) of the servo control device (110) and is connected to the intermediate part (72).

6. The valve according to any one of the preceding claims, characterized in that the intermediate part (72) and the connecting part (102) are arranged stationarily on the valve housing (54).

7. The valve according to any one of the preceding claims, characterized in that the regulating piston (68), at least in the area of the control port (40) and at least in the area, in which, at least partially, one of the energy storage devices (70) is accommodated, is designed as a hollow piston, wherein one diaphragm (88), designed as a screw-in piece (86), is inserted into the regulating piston (68), both cavities of which are permanently connected to each other in a fluid-conveying manner.

8. The valve according to any one of the preceding claims, characterized in that the regulating piston (68) can advantageous be equipped with a stop part (78) on the side of the intermediate part (72), which can be brought into contact with the valve housing (54) and intermediate part (72), respectively, in one and the other stop position, respectively.

9. The valve according to any one of the preceding claims, characterized in that the control port (40) is inserted in the axial direction into the valve housing (54) and the fluid inlet (64) and the fluid outlet (66) extend in the radial direction through the valve housing (54), wherein the hollow piston in conjunction with the valve housing (54) defines an annular space (80) on the outer circumference, which annular space completely transverses the fluid outlet (66) in the other stop position of the regulating piston (68).

10. A device for damping the hoist for at least one hydraulic load (2), in particular in the form of a hydraulic power cylinder, having a valve according to any one of the above claims, which is connected to the control port (40) of the valve in a fluid-conveying manner by a working chamber (8), the fluid inlet (64) of which valve is connected to a pressure supply source (P) and the fluid outlet (66) of which is connected to a pressure accumulator device (20).

11. The device according to claim 10, characterized in that one of the working chambers (8), which is connected to the control port (40) of the valve, is simultaneously integrated into the fluid-conveying connection (26) between the valve and the pressure accumulator device (20) via a shut-off valve (28), and that a further working chamber (10) of the hydraulic load (2) is connected to a return line (32) to the tank side (T) via a further shut-off valve (30).
